(19) United States
(12) Patent Application Publication
(10) Pub. No.: US 2014/0335726 A1
(43) Pub. Date: Nov. 13, 2014

(54) ELECTRICAL CONNECTOR HAVING A SPRING TAB FOR CONTACTING WITH AN EXTERNAL CABINET

(71) Applicant: HON HAI PRECISION INDUSTRY CO., LTD., NEW TAIPEI (TW)

(72) Inventor: DAO-KUAN ZHANG, Kunshan (CN)

(73) Assignee: HON HAI PRECISION INDUSTRY CO., LTD., NEW TAIPEI (TW)

(21) Appl. No.: 14/272,710

(22) Filed: May 8, 2014

(30) Foreign Application Priority Data
May 8, 2013 (CN) 2013202439156

(51) Int. Cl. H01R 13/648

(52) U.S. Cl. CPC H01R 13/648
USPC 439/607.01

(57) ABSTRACT

An electrical connector (100) comprises an inslulative housing (2) and a shielding shell (8) surrounding the insulative housing. The inslulative housing includes a front wall (21) and a receptacle port (28, 29) extending along a front-to-back direction for insertion of a plug connector. The shielding shell includes a front shell (811) surrounding the front wall. The shielding shell includes a front spring tap (8112) extending cantilevered along a left-to-right direction. The front spring tap includes a first end (8113) connected with the front shell and a second end (8114) disposed in front of the front shell so that the first end is positioned close to a left edge (8115) of the front shell and the second end is positioned close to a right edge (8116) of the front shell.

### BACKGROUND OF THE INVENTION

1. Field of the Invention

The present invention relates to an electrical connector having a shielding shell for mounting to an external cabinet, specially relates to a spring tab of the shielding shell for contacting with the external cabinet.

2. Description of Related Art

China Patent Issue Number CN201440550U issued on Apr. 21, 2010 discloses an electrical connector with a shielding shell. The shielding shell has two top spring tabs extending from an upper portion thereof The shielding shell has a top shell with two top stamping holes formed through stamping the top spring tabs out of the top shell. The electrical connector is mounted to an inner wall of an external cabinet by sliding inclinedly downwardly from a left corner to a right corner and firstly contacting the top spring tabs with the external cabinet. The electrical connector is then tilted so that the shielding shell faces and connects with the inner wall of the external cabinet. Since the top spring tabs are too short, they may undergo plastic deformation during the contacting process and thus not contact with the inner wall of the external cabinet reliably after the tilting process.

An electrical connector having a secured spring tab structure is desired.

### SUMMARY OF THE INVENTION

Accordingly, an object of the present invention is to provide an electrical connector having a secure structure for mating with an inner wall of an external cabinet.

In order to achieve the object set forth, the invention provides an electrical connector including an inslulative housing and a shielding shell surrounding the insulative housing. The inslulative housing includes a front wall and a receptacle port extending along a front-to-back direction for insertion of a plug connector. The shielding shell includes a front shell surrounding the front wall. The shielding shell includes a front spring tap extending cantilevered along a left-to-right direction. The front spring tap includes a first end connected with the front shell and a second end disposed in front of the front shell so that the first end is positioned close to a left edge of the front shell and the second end is positioned close to a right edge of the front shell.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an electrical connector;

FIG. 2 is an exploded view of the electrical connector shown in FIG. 1;

FIG. 3 is another exploded view of the electrical connector shown in FIG. 2; and

FIG. 4 is a perspective view of a second embodiment of an electrical connector.

### DETAILED DESCRIPTION OF THE PREFERRED EMBODIMENT

Reference will now be made in detail to the preferred embodiment of the present invention.

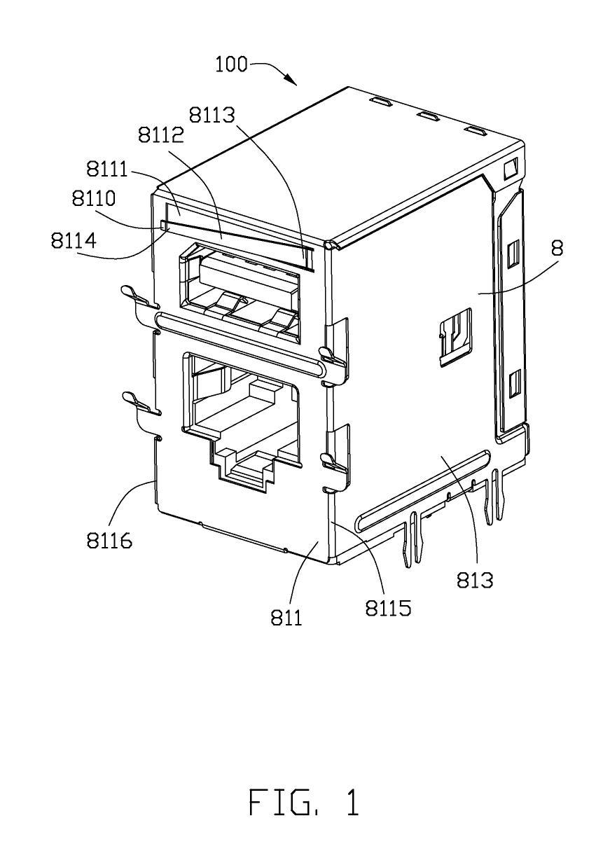

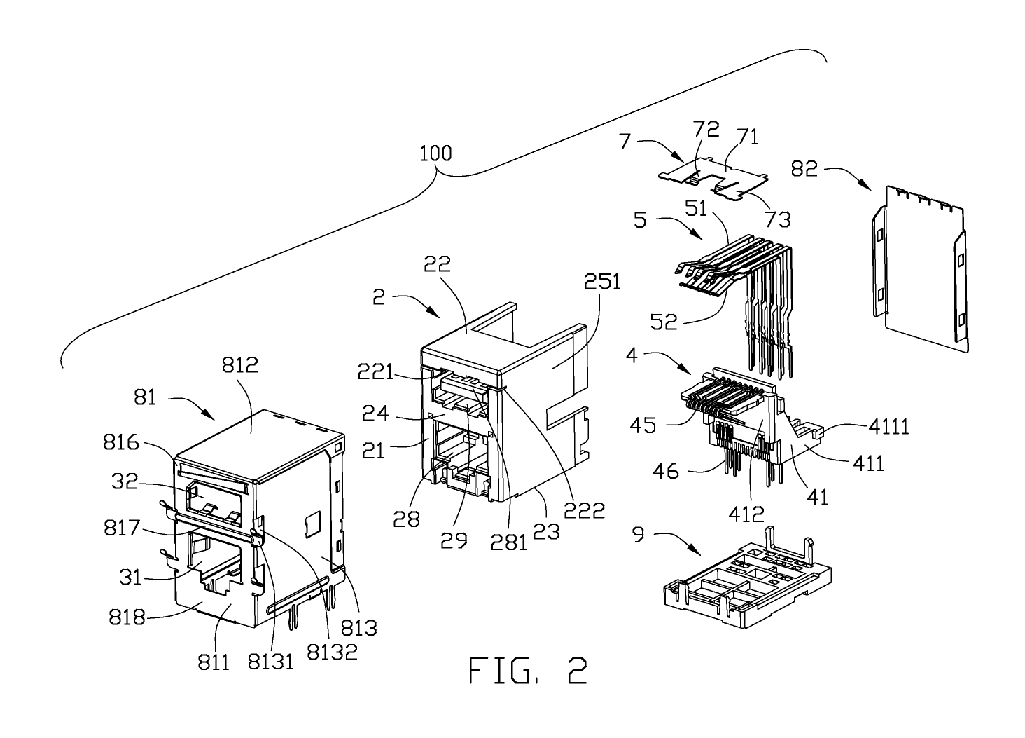

Referring to FIGS. 1-3, an electrical connector 100 of a first embodiment is shown. The electrical connector 100 could be mounted on an exterior substrate (not shown) and mated with a RJ45 plug (not shown) and a USB plug (not shown). The electrical connector 100 includes an insulative housing 2, a terminal module 4 and a plurality of contacts 5 mounted to the insulative housing 2 along a back-to-front direction, an anti-mistaking or grounding plate 7 mounted on the insulative housing 2 along a front-to-back direction, a padded block 9 mounted to the insulative housing 2 along a bottom-to-top direction, and a shielding shell 8 enclosing the insulative housing 2.

The insulative housing 2 has a front wall 21 extending vertically, a top wall 22 extending horizontally, a bottom wall 23 extending parallel to the top wall 23, a middle wall 24 positioned between the top wall 22 and the bottom wall 23, a left side wall 251 extending along the front-to-back direction, and a right side wall 252 extending parallel to the left side wall 251. The top wall 22 defines two long grooves 221 and two short slots 222 at an inner side thereof The insulative housing 2 defines an upper port 28 surrounded by the top wall 22, the middle wall 24 and the left and right walls 251, 252. The insulative housing 2 also defines a lower port 29 surrounded by the bottom wall 23, the middle wall 24 and the left and right walls 251, 252. The upper port 28 is stacked upon the lower port 29. The upper port 28 is used for mating with a USB plug connector and the lower port 29 is used for mating with a RJ45 plug connector. The insulative housing 2 includes a tongue plate 281 disposed in the upper port 28. The insulative housing 2 defines a mounting port 200 located behind the upper and lower ports 28, 29 and connected with them.

The terminal module 4 is mounted into the mounting ports 200 along the back-to-front direction. The terminal module 4 has an insulative carrier 41, an inner PCB (printed circuit board) 43 assembled on the insulative carrier 41 vertically, a set of mating terminals 45 soldered to the inner PCB 43, and a set of mounting terminals 46 for mounting onto an exterior substrate. The mating terminals 45 electrically connect with the mounting terminals 46 respectively through the inner PCB 43. The insulative carrier 41 includes a bottom wall 411 and a side wall 412 extending upwardly therefrom. The bottom wall 411 has a mating post 4111 for held by a mating cut 253 of the insulative housing 2. The bottom wall 41 defines a plurality of holding slot 414 for retention of the plurality of contacts 5 respectively. The terminals module 4 also has a plurality of transformer coil module 431 mounted on the inner PCB 43.

The plurality of contacts 5 include a set of upper contacts 51 and a set of lower contacts 52. The set of lower contacts 52 include four conductive contacts for transmitting universal serial bus signal. The set of upper contacts 51 include five conductive contacts for transmitting power.

The anti-mistaking plate 7 is made of metal material and received in the upper port 28. The anti-mistaking plate 7 has a body portion 71, two elastic taps 72 extending forwardly from the body portion 71, and two retention taps 73 positioned at two opposite sides of the elastic taps 72 and extending forwardly from the body portion 71. The two elastic taps 72 are received in the two long grooves 221 respectively. The retention taps 73 are received and hold in the two short slots 222 respectively.

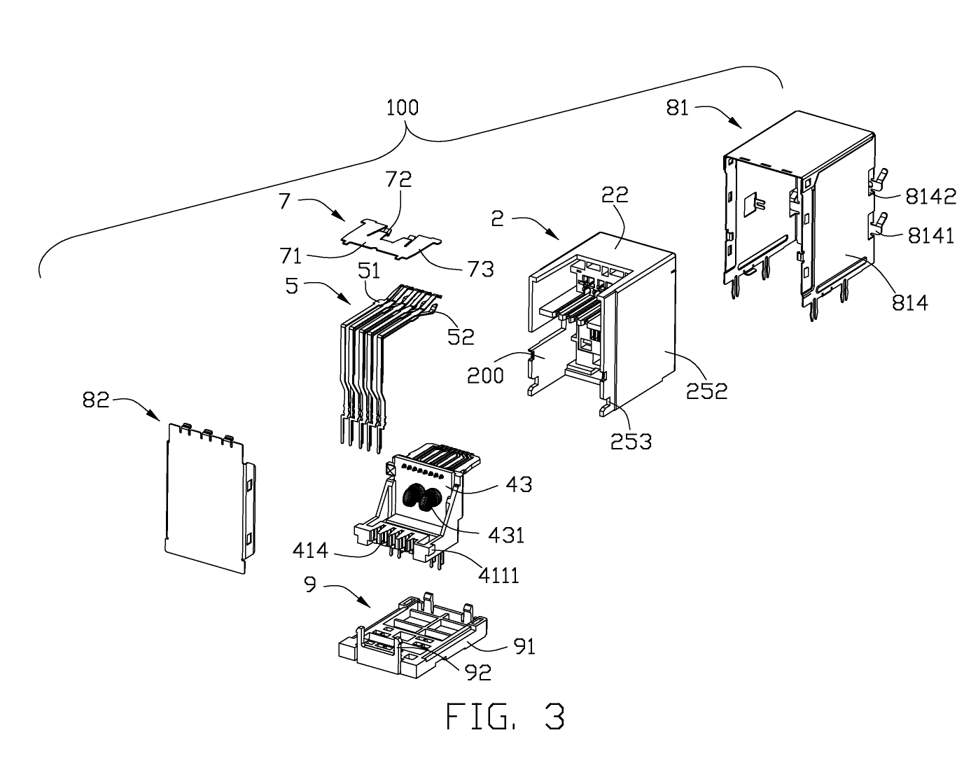

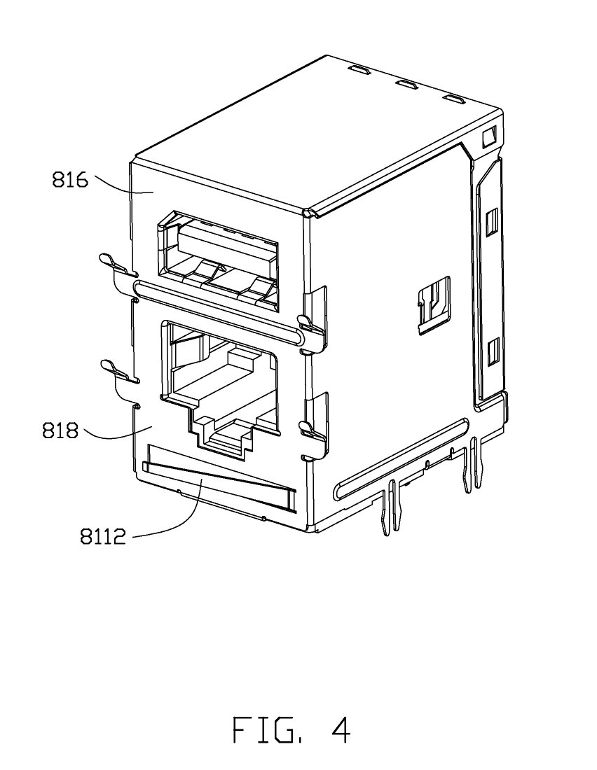

The shielding shell 8 includes a front part 81 and a rear part 82 assembled together with each other. The front part 81 has a front shell 811, a top shell 812, a left side shell 813, and a right side hell 814. The front shell 81 includes a front spring tap or tang 8112 extending cantilevered along a left-to-right direction and a stamping hole 8111 located behind the front spring tap 8112. The front shell 81 defines a lower opening 31 and an upper opening 32 corresponding to the lower port 28 and the upper port 29. The front shell 81 includes a top portion 816 located above the upper opening 32, a middle portion 817 located between the lower and upper openings 31, 32, and a bottom portion 818 located below the lower opening 3. The front spring tap 8112 is disposed on the top portion 816 (FIG. 3) or the lower portion 818 (FIG. 4). The stamping hole 8111 is formed by stamping the front spring tap 8112 from the front shell 81. The front spring tap 8112 includes a first end 8113 connected with the front shell 811 and a second end 8114 disposed in front of the front shell 811. The first end 8113 is positioned close to a left edge 8115 of the front shell 811 and the second end 816 is positioned close to a right edge 8116 of the front shell 811. The second end 8114 is a free end and has a contacting portion 8110 for abutting an external cabinet (not shown). The contacting portion 8110 is disposed parallel to the front wall 21 of the insulative housing 2. The first end 8113 is wider than the second end 8114 along a vertical direction perpendicular to the extending direction of the front spring tap 8112.

The shielding shell 8 includes a left spring tap 8131 stamped from the left side shell 813 and extending upwardly and forwardly. The left side shell 813 defines a left stamping hole 8132 formed through stamping the left spring tap 8131. The shielding shell 8 also includes a right spring tap 8141 stamped from the right side shell 814 and extending upwardly and forwardly. The right side shell 814 defines a right stamping hole 8142 formed through stamping the right spring tap 8141. All of the front spring tap 8112, the left spring tap 8131 and the right spring tap 8141 are used for contacting with an inner wall of an external cabinet (not shown). The electrical connector 100 is mounted to the external cabinet by an inclined style and the front spring tap 8112 firstly contacting with an inner wall of the external cabinet. The front spring tap 8112 is enough long for elastic deformation during the contacting process and contacting closely with the inner wall of the external cabinet after a rotation process.

The padded block 9 is mounted on the insulative housing 2 along a bottom-to-top direction. The padded block 9 includes a base body 91 extending along the front-to-back direction and a plurality of locking posts 92 extending therefrom along the bottom-to-back direction. The locking posts 92 lock with the insulative housing 2. The padded block 9 is used for adjusting a height of the electrical connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. An electrical connector comprising:
an inslulative housing including a front wall and a receptacle port extending along a front-to-back direction for insertion of a plug connector; and
a shielding shell surrounding the insulative housing and including a front shell surrounding the front wall; wherein
the shielding shell includes a front spring tab extending cantilevered along a left-to-right direction, the front spring tap including a first end connected with the front shell and a second end disposed in front of the front shell, the first end positioned close to a left edge of the front shell and the second end positioned close to a right edge of the front shell.

2. The electrical connector as claimed in claim 1, wherein said receptacle port includes a lower port and an upper port, the front shell including a top portion located above the upper port, a middle portion located between the lower and upper ports, and a bottom portion located below the lower port.

3. The electrical connector as claimed in claim 2, wherein said front spring tap connects with one of the top portion and the bottom portion.

4. The electrical connector as claimed in claim 1, wherein said front spring tap is stamped out of the front shell and the front shell defines a stamping hole located behind the front spring tap.

5. The electrical connector as claimed in claim 1, wherein said second end is a free end and has a contacting portion for abutting an external cabinet, said contacting portion being disposed parallel to the front wall of the insulative housing.

6. The electrical connector as claimed in claim 1, wherein said first end is wider than the second end along a vertical direction.

7. An electrical connector comprising:
an insulative housing defining at least one rectangular receiving cavity forwardly communicating with an exterior along a front-to-back direction via a rectangular front opening which extends through a front face of the housing, said rectangular front opening defining a long edge and a short edge perpendicular to each other, said receiving cavity defining a long side and a short side perpendicular to each other corresponding to the long edge and the short edge;
a plurality of contacts disposed in the housing with contacting sections exposed within the receiving cavity;
a metallic shield including a front plate to cover the front face except the front opening, said front plate defining at least one spring tang unitarily split and extending therefrom obliquely and forwardly beside the long edge of the opening in a transverse direction perpendicular to said front-to-back direction.

8. The electrical connector as claimed in claim 7, wherein the shield further includes a pair of spring fingers unitarily extending forwardly respectively from two opposite lateral sides of the front face in a vertical direction perpendicular to said transverse direction so as to cooperate with said spring tang to form three-point contact with a corresponding panel.

9. The electrical connector as claimed in claim 8, wherein said pair of spring fingers essentially located beyond two opposite lateral side edges of the front plate, are derived and split from two lateral side plates of the shield which cover the corresponding opposite lateral walls of the housing.

10. The electrical connector as claimed in claim 8, wherein said housing further defines another receiving cavity forwardly exposed to the exterior through the shield, and said pair of spring fingers are located between said two receiving cavity in a vertical direction perpendicular to both said front-to-back direction and said transverse direction in a front view.

11. The electrical connector as claimed in claim 7, wherein the receiving cavity is provided with opposite first and second pairs of grounding tangs along two opposite long sides thereof, respectively, and the first pair of grounding tangs unitarily extend rearwardly from the front plate of the shield while the second pair of grounding tangs unitarily extends rearwardly from a horizontal grounding plate which is discrete from the shield and assembled into the housing behind the front plate.

12. The electrical connector as claimed in claim 11, wherein said housing forms a pair of slots by two sides of the receiving cavity to retain the grounding plate to the housing.

13. The electrical connector as claimed in claim 11, wherein said grounding plate forwardly abuts against the front plate of the shield.

14. The electrical connector as claimed in claim 7, wherein said spring tang is located adjacent to a top plate of the shield, and said shield forms no part above the top plate.

15. The electrical connector as claimed in claim 7, wherein said spring tang is longer than the long edge in the transverse direction.
